(19) United States
(12) Patent Application Publication
(10) Pub. No.: US 2015/0004417 A1
(43) Pub. Date: Jan. 1, 2015

(54) FLUOROELASTOMER HALLOYSITE NANOCOMPOSITE

(71) Applicant: XEROX CORPORATION, Norwalk, CT (US)

(72) Inventors: Brynn Dooley, Toronto (CA); Yu Qi, Oakville (CA); Qi Zhang, Milton (CA); Carolyn Moorlag, Mississauga (CA)

(21) Appl. No.: 13/928,647

(22) Filed: Jun. 27, 2013

(51) Int. Cl. C08K 7/26

(52) U.S. Cl. CPC C08K 7/26
USPC 428/421; 524/445

(57) ABSTRACT

A polymer composite comprising a fluoroelastomer binder. A plurality of halloysite nanotubes are dispersed in the fluoroelastomer binder. Xerographic components employing the polymer composite are disclosed.

### DETAILED DESCRIPTION

1. Field of the Disclosure

The present disclosure is directed to a fluoroelastomer halloysite nanocomposite material and articles of manufacture comprising the fluoroelastomer halloysite nanocomposite material.

2. Background

Various types of fluoropolymers are known for use in industry. These fluoropolymers include fluoroplastic resins, such as polytetrafluoroethylene (PTFE); perfluoroalkoxy polymer resin (PFA); and fluorinated ethylenepropylene copolymers (FEP). Fluoroplastics are generally formed without a cross-linking agent and therefore retain the ability to be melted upon re-heating. However, fluoroplastics generally do not provide adequate elastomeric properties desirable in many applications.

Fluoroelastomers provide increased elastomeric properties compared to fluoroplastics. Fluoroelastomers are known for use in a wide variety of applications. Such applications include hydrophobic coatings for anti-contamination, anti-sticking and self-cleaning surfaces; chemically resistant and/or thermally stabile elastic components in consumer and industrial applications; lubricating and/or protective coatings; xerographic components, such as outer release coatings for fusers, as well as a variety of other applications.

Fillers, such as carbon nanotubes, are often employed in fluoroelastomer compositions in order to modify the properties of the fluoroelastomer materials. For example, carbon nanotube reinforced fluoroelastomer topcoats are being developed to provide more mechanically robust fuser topcoats. However, carbon nanotubes are costly to produce and available in relatively small quantities compared to many other bulk chemicals. In addition, the production of carbon nanotubes is energy intensive. Furthermore, the impact on the environment and human health from long-term exposure to freeform carbon nanotubes is unknown.

Discovering a novel fluoroelastomer composite material that can address one or more of the problems associated with the known fluoroelastomer carbon nanotube composites would be a desirable step forward in the art.

### SUMMARY

An embodiment of the present disclosure is directed to a polymer composite. The composite comprises a fluoroelastomer binder. A plurality of halloysite nanotubes are dispersed in the fluoroelastomer binder.

Another embodiment is directed to a xerographic component. The xerographic component comprises a substrate. A nanocomposite layer is formed on the substrate. The nanocomposite layer comprises a fluoroelastomer binder and a plurality of halloysite nanotubes dispersed in the fluoroelastomer binder.

Yet another embodiment of the present disclosure is directed to a fuser. The fuser comprises a substrate. A nanocomposite layer is formed on the substrate. The nanocomposite layer comprises a fluoroelastomer binder and a plurality of halloysite nanotubes dispersed in the fluoroelastomer binder. The plurality of halloysite nanotubes have an average aspect ratio of at least 5. The halloysite nanotubes have a concentration of less than 20% by weight, based on the total weight of the nanocomposite layer. The nanocomposite layer formed on the substrate has a tensile strength ranging from about 600 psi to about 5000 psi; a toughness ranging from about 1000 in·lbf/in³ to about 5000 in·lbf/in³; and a percentage ultimate strain ranging from about 100% to about 600%.

One or more of the following advantages may be realized by embodiments of the present disclosure: A fluoroelastomer halloysite nanocomposite that exhibits improvements in tensile stress and/or tensile strain and/or toughness relative to the parent fluoroelastomer without the halloysite; a fluoroelastomer halloysite nanocomposite that maintains chemical stability, thermal stability and/or a relatively low coefficient of friction imparted by the fluoroelastomer; significant interaction between the halloysite nanotubes and the fluoroelastomer binder and/or enhanced reinforcement of the fluoroelastomer compared with conventional fillers; improved wear of a fuser top coat made using the fluoroelastomer halloysite nanocomposite; the ability to maintain release properties (surface free energy) of the fluoroelastomer; a relatively low cost filler material compared to carbon nanotubes; or providing a more biocompatible fluoroelastomer nanocomposite material.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrates embodiments of the present teachings and together with the description, serve to explain the principles of the present teachings.

FIG. 1 illustrates an article of manufacture comprising a fluoroelastomer halloysite composite layer, according to an embodiment of the present disclosure.

FIG. 2 illustrates a schematic view of a fuser system, according to an embodiment of the present disclosure.

It should be noted that some details of the figure have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. In the drawings, like reference numerals have been used throughout to designate identical elements. In the following description, reference is made to the accompanying drawing that forms a part thereof, and in which is shown by way of illustration a specific exemplary embodiment in which the present teachings may be practiced.

The following description is, therefore, merely exemplary.

### Halloysite Nanocomposite Compositions

An embodiment of the present disclosure is directed to a fluoroelastomer halloysite nanocomposite composition. The composition comprises a fluoroelastomer binder and a plurality of halloysite nanotubes dispersed in the fluoroelastomer binder. Other optional ingredients can be included in the composition, as discussed below.

a. Fluoroelastomer Binder

Any suitable fluoroelastomer binder can be employed, depending on the desired characteristics of the nanocomposite composition. Example fluorelastomers include polyperfluoropolyethers and polymers having at least one monomer repeat unit selected from the group consisting of tetrafluoroethylene, vinylidene fluoride, hexafluoropropylene, perfluoro(methyl vinyl ether), perfluoro(ethyl vinyl ether) and perfluoro(propyl vinyl ether).

In an embodiment, the fluoroelastomer binder is a cross-linked polymer made by combining a cure site monomer and a monomeric repeating unit selected from the group consisting of a vinylidene fluoride, a hexafluoropropylene, a tetrafluoroethylene, a perfluoro(methyl vinyl ether), a perfluoro(propyl vinyl ether), a perfluoro(ethyl vinyl ether) and combinations thereof. Any suitable cure site monomer can be employed. The cure site monomer can be, for example, 4-bromoperfluorobutene-1; 1,1-dihydro-4-bromoperfluorobutene-1; 3-bromoperfluoropropene-1; 1,1-dihydro-3-bromoperfluoropropene-1, or any other suitable cure site monomer.

In an embodiment, suitable fluoroelastomers include: i) copolymers of vinylidenefluoride and hexafluoropropylene; ii) terpolymers of vinylidenefluoride, hexafluoropropylene and tetrafluoroethylene; and iii) tetrapolymers of vinylidenefluoride, hexafluoropropylene, tetrafluoroethylene and a cure site monomer. Any suitable cure site monomers can be employed, including those described above.

Further examples of such fluoroelastomers include those described in detail in U.S. Pat. Nos. 5,166,031, 5,281,506, 5,366,772, 5,370,931, 4,257,699, 5,017,432 and 5,061,965, the disclosures each of which are incorporated by reference herein in their entirety. Examples of commercially known fluoroelastomers include VITON A®, VITON E®, VITON E 60C®, VITON E430®, VITON 910®, VITON GH® and VITON GF®. The VITON® designation is a Trademark of E.I. DuPont de Nemours, Inc. Other commercially available fluoroelastomers include FLUOREL 2170®, FLUOREL 2174®, FLUOREL 2176®, FLUOREL 2177® and FLUOREL LVS 76®, FLUOREL® being a Trademark of 3M Company. Additional commercially available materials include AFLASO a poly(propylene-tetrafluoroethylene) and FLUOREL II® (LII900) a poly(propylene-tetrafluoroethylenevinylidenefluoride) both also available from 3M Company, as well as the Tecnoflons identified as FOR-60KIR®, FOR-LHF®, NM® FOR-THF®, FOR-TFS®, TH®, and TN505®, available from Montedison Specialty Chemical Company.

In embodiments, the fluoroelastomer matrix can include polymers cross-linked with a curing agent (also referred to as a cross-linker or cross-linking agent) to form elastomers that are relatively soft and display elastic properties. For example, when the polymer matrix uses a vinylidenefluoride containing fluoropolymer, the curing agent can include a bisphenol compound, a diamino compound, an aminosilane, and/or a phenolsilane compound. An exemplary bisphenol cross-linker can be VITON® curative No. 50 (VC-50) available from E.I.Dupont de Nemours, Inc. VC-50 can be soluble in a solvent suspension and cross-links reactive sites with, for example, VITON GF®.

b. Halloysite Nanotubes

Halloysite (Al₂Si₂O₅(OH)₄.nH₂O)) is a well known, economically viable clay material that can be mined from deposits as a raw mineral. Halloysite is an aluminosilicate chemically similar to kaolin which exhibits a range of morphologies.

One predominant form of halloysite is a hollow tubular structure in the submicrometer range. The size of known halloysite tubules can vary depending on the deposit. Known sizes include tubules that are, for example, about 500 nm to about 1000 nm in length and about 15 nm to about 100 nm in inner diameter, although dimensions outside these ranges may be possible. The neighboring alumina and silica layers, and their water of hydration, create a packing disorder causing the halloysite tubules to curve and roll up, forming multilayer tubes. The nanotubes exhibit a naturally exfoliated morphology. Thus chemical means are not necessary to disperse the material.

Any suitable halloysite nanotubes can be employed in the compositions of the present disclosure. Examples include halloysite nanotubes having an average aspect ratio of at least about 5, such as ratios ranging from about 10 to about 100, or about 20 to about 50. Example nanotubes have diameters less than about 200 nm, such as diameters ranging from about 10 nm to about 100 nm, or about 15 nm to about 75 nm.

The halloysite nanotubes can be present in the nanocomposite in any desired amount. Examples include amounts less than 20% by weight, such as concentrations ranging from about 1 weight % to about 15 weight %, based on the total weight of dried solids, such as about 2 weight % to about 10 weight %. For example, the composite layers of the present disclosure can contain about 3 weight % to about 5, 8 or 10 weight %. All percentages are relative to the weight of the total dry solids (e.g., weight of the final composite coating after curing is complete).

The halloysite nanotubes can be modified/functionalized to increase the mechanical and/or surface properties through various physical and/or chemical modifications. For example, the halloysite nanotubes can be surface-modified with a material chosen from perfluorocarbon, perfluoropolyether, perfluorinated alkoxysilanes, and/or polydimethylsiloxane. Techniques for modifying the surface of halloysite nanotubes are well known in the art.

c. Conductive Filler

The nanocomposite compositions of the present disclosure can optionally include one or more conductive fillers. Any suitable conductive fillers can be employed. Examples of suitable fillers include metal particles, metal oxide particles, carbon nanotubes, carbon black, graphene, graphite, alumina, silica, boron nitride, aluminum nitride, silicon carbide and mixtures thereof.

The amount of filler employed may depend on the desired surface resistivity or thermal conductivity of the product being manufactured. For example, a conductive filler can be included in an amount sufficient to result in a nanocomposite layer having an electrical surface resistivity ranging from about less than 1×10¹² Ω/sq, or less than 1×10¹° Ω/sq, or less than 1×10⁸ Ω/sq; or having a thermal conductivity ranging from about 0.1 W·m/K to about 6 W·m/K, or from about 0.2 W·m/K to about 4 W·m/K, or from about 0.4 W·m/K to about 2 W·m/K.

In an embodiment, the composites of the present disclosure do not include significant amounts of carbon nanotubes. For example, the composites can include less than 1% by weight carbon nanotubes, such as less than 0.5% or 0.1% by weight carbon nanotubes, based on the total weight of the dried solids in the composite.

d. Other Optional Ingredients

In addition to conductive fillers, any other desired ingredients can optionally be employed in the compositions of the present disclosure, including dispersing agents, additional fillers and release agents.

### Article of Manufacture

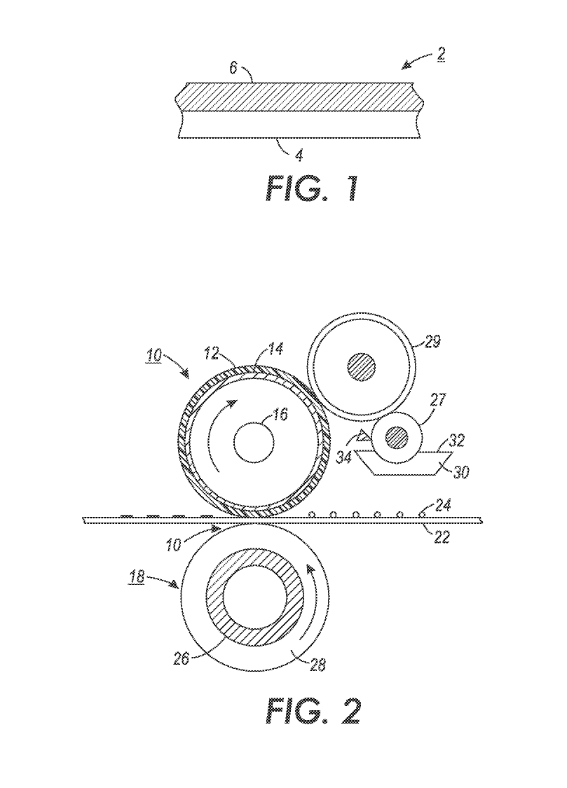

Referring to FIG. 1, the present disclosure is also directed to a xerographic printing device comprising a substrate 4. A fluoroelastomer halloysite nanocomposite layer 6 is coated over the substrate 4. The nanocomposite layer 6 comprises a fluoroelastomer binder and a plurality of halloysite nanotubes dispersed in the fluoroelastomer binder, as discussed herein.

The substrate 4 over which the nanocomposite layer is coated can be any suitable substrate. Examples of substrate materials include glass, semiconductors, such as silicon or gallium arsenide, metals, ceramics, plastics, elastomers, such as silicone or fluoroelastomers, and combinations thereof.

Examples of xerographic printing device components in which the nanocomposite compositions of the present disclosure may be used include fuser members, fixing members, pressure rollers and release agent donor members. The phrase “printing device” as used herein encompasses any apparatus, such as a digital copier, bookmaking machine, facsimile machine, multi-function machine, and the like, which performs a print outputting function for any purpose.

An example fuser member is described in conjunction with a fuser system as shown in FIG. 2, where the numeral 10 designates a fuser roll comprising an outer layer 12 upon a suitable substrate 14. The substrate 14 can be a hollow cylinder or core fabricated from any suitable metal such as aluminum, anodized aluminum, steel, nickel, copper, and the like. Alternatively, the substrate 14 can be a hollow cylinder or core fabricated from non-metallic materials, such as polymers. Example polymeric materials include polyamide, polyimide, polyether ether ketone (PEEK), Teflon/PFA, and the like, and mixtures thereof, which can be optionally filled with fiber such as glass, and the like. In embodiments, a polymeric or other core material may be desired that is formulated to include carbon nanotubes as described for the coating layers herein. Such core layers can further increase the overall thermal conductivity of the fuser member. In an embodiment, the substrate 14 can be an endless belt (not shown) of similar construction, as is well known in the art.

Referring again to FIG. 2, the substrate 14 can include a suitable heating element 16 disposed in the hollow portion thereof, according to an embodiment of the present disclosure. Any suitable heating element can be employed. Suitable heating elements are well known in the art.

Backup or pressure roll 18 cooperates with the fuser roll 10 to form a nip or contact arc 20 through which a copy paper or other substrate 22 passes, such that toner images 24 on the copy paper or other substrate 22 contact the outer layer 12 of fuser roll 10. As shown in FIG. 2, the backup roll 18 can include a rigid steel core 26 with a soft surface layer 28 thereon, although the assembly is not limited thereto. Sump 30 contains a polymeric release agent 32 which may be a solid or liquid at room temperature, but is a fluid at operating temperatures.

In an embodiment of FIG. 2 for applying the polymeric release agent 32 to outer layer 12, two rotatably mounted release agent delivery rolls 27 and 29 are provided to transport release agent 32 from the sump 30 to the fuser roll surface. As illustrated, roll 27 is partly immersed in the sump 30 and transports on its surface release agent from the sump to the delivery roll 29. By using a metering blade 34, a layer of polymeric release fluid can be applied initially to delivery roll 29 and subsequently to the outer layer 12 of the fuser roll 10 in a controlled thickness ranging from submicrometer thickness to thickness of several micrometers of release fluid. Thus, by metering device 34 a desired thickness, such as about 0.1 micrometers to 2 micrometers or greater, of release fluid can be applied to the surface of fuser roll 1.

The design illustrated in FIG. 2 is not intended to limit the present disclosure. For example, other well known and after developed electrostatographic printing apparatuses can also accommodate and use the fuser and fixer members described herein. For example, some embodiments do not apply release agent to the fuser roll surface, and thus the release agent components can be omitted. In other embodiments, the depicted cylindrical fuser roll can be replaced by an endless belt fuser member. In still other embodiments, the heating of the fuser member can be by methods other than a heating element disposed in the hollow portion thereof. For example, heating can be by an external heating element or an integral heating element, as desired. Other changes and modifications will be apparent to those in the art.

As used herein, the term “fuser” or “fixing” member, and variants thereof, may be a roll, belt such as an endless belt, flat surface such as a sheet or plate, or other suitable shape used in the fixing of thermoplastic toner images to a suitable substrate. It may take the form of a fuser member, a pressure member or a release agent donor member.

In an embodiment, the outer layer 12 comprises any of the fluoroelastomer nanocomposite compositions of the present disclosure. The nanocomposite composition can include any of the fluoroelastomers and halloysite nanotubes disclosed herein. In an embodiment, the fluoroelastomer nanocomposite materials can be chosen to provide properties that are suitable for fuser applications. For example, the fluoroelastomer can be a heat stable elastomer material that can withstand elevated temperatures generally from about 90° C. up to about 200° C., or higher, depending upon the temperature desired for fusing or fixing the toner particles to the substrate. The fluoroelastomer binder used in the fuser or fixing member can also be chosen to be resistant to degradation by any release agent that may be applied to the member.

In an embodiment, there may be one or more intermediate layers between the substrate 14 and the outer layer of the fluoroelastomer nanocomposite. Typical materials having the appropriate thermal and mechanical properties for such intermediate layers include silicone elastomers, fluoroelastomers and EPDM (ethylene propylene hexadiene). Examples of designs for fusing and fixing members known in the art and are described in U.S. Pat. Nos. 4,373,239; 5,501,881; 5,512,409 and 5,729,813, the entire disclosures of which are incorporated herein by reference.

The nanocomposite material containing halloysite nanotubes and fluoroelastomer can have improved mechanical properties compared to the mechanical properties of the fluoroelastomer alone, without any filler. For example, the nanocomposite can have a tensile strength ranging from about 600 psi to about 5000 psi, or from about 800 psi to about 3000 psi, or from about 1000 psi to about 2500 psi; a toughness ranging from about 1000 in·lbf/in³ to about 5000 in·lbf/in³, or from about 1500 to about 4000 in·lbf/in³, or from about 2100 to about 3000 in·lbf/in³; and/or a percentage ultimate strain in the range of about 100% to about 600%, or from about 150% to about 500%, or from about 200% to about 350%, where the percentage ultimate strain is determined using a universal INSTRON testing machine (INSTRON, Norwood, Mass.). The toughness is determined by an integral average stress/strain at the break point, that is, the area under the stress-strain curve is considered to be a measure for the toughness as known to one of ordinary skill in the art. The increase in toughness and tensile stress and strain can vary outside of these ranges, depending on the fluoroelastomer material used in the coating, among other things.

Despite incorporation of halloysite, which is a hydrophilic filler, the fluoroelastomer-halloysite nanotube nanocomposite has a hydrophobic surface such that the surface free energy of the composite ranges from about 18 mN/m to about 28 mN/m, or from about 19 mN/m to about 26 mN/m, or from about 20 mN/m to about 24 mN/m, where the surface free energy can be calculated by using Lewis Acid-Base method from the results of a contact angle measurement of water, diiodomethane, and dimethylformamide using a FIBRO DAT 1100 instrument (Fibro Systems AB, Sweden). As would be readily understood by one of ordinary skill in the art, this method of determining surface free energy involves independently measuring the contact angles of the three liquids. The data from each liquid is input to a model (acid-base) and used to calculate the surface free energy.

### EXAMPLES

Halloysite-fluoroelastomer nanocomposite materials were prepared with different wt % halloysite loading by compounding halloysite and fluoroelastomer (Viton GF) in a Haake Rheomix using a let down extrusion process. 16 grams Halloysite nanotube powder was mixed with 64 grams Viton GF (E. I. DuPont Inc.) using an internal compounder, such as Haake Rheomix 600 at a rotor speed of about 20 revolutions per minute (rpm) for about 60 minutes at 150-170° C. to form about 80 grams of fluoroelastomer composite containing about 20 wt % of halloysite nanotubes. The mixing was repeated multiple times. Then 20 grams of the composite was mixed with 60 grams of Viton GF by let-down process to produce 5 wt % halloysite/Viton composite; and 40 grams of the composite containing 20 wt % of halloysite nanotubes was mixed 40 grams of Viton GF by let-down process to produce 10 wt % halloysite/Viton composite. The composite mixtures were heated in Haake Rheomix to 150° C. and compounded at 20 rpm for 60 minutes. The compounding process was repeated for 3 times.

A halloysite/Viton coating dispersion was prepared by mixing the let-down halloysite/Viton composite with the coating surfactants and curative agent, N-(2-Aminoethyl)-3-Aminopropyltri-methoxysilane (AO700) in methyl isobutyl ketone (MIBK) by milling for 20-22 hours.

Prototype fuser rolls with topcoats containing halloysite nanotubes were fabricated by flow coating a Viton-GF/halloysite/curative dispersion onto a silicone substrate. An iGen silicone roll was mounted on a motorized rotation stage and cleaned with IPA. The rotational speed was 75 RPM and the coating speed was 1 mm/s. The flow rate was controlled at 8-12 ml/min by a syringe pump to achieve the fuser topcoat with the thickness of 20-30 microns. The coating was air dried and followed by curing at ramp temperatures, e.g., at about 149° C. for about 2 hours, and at about 177° C. for about 2 hours, then at about 204° C. for about 2 hours and then at about 232° C. for about 6 hours for a post cure.

The wet layer was air dried and cured at an elevated temperature. A control layer was made by depositing a similar Viton-GF curative, except without the halloysite filler, onto a silicone substrate using the same deposition and curing process.

The toughness was determined by an integral average stress/strain at the break point, that is, the area under the stress-strain curve is considered to be a measure for the toughness as known to one of ordinary skill in the art. As illustrated by Table 1 below, the halloysite/Viton GF nanocomposites exhibited significantly improved mechanical strength and toughness relative to the Viton GF control layer. Further, the data shows a higher increase in both tensile stress and toughness for 5 weight % halloysite than for 10 weight % halloysite for these particular examples. It is possible, although the data is not conclusive, that greater improvements in tensile stress and toughness may be achieved at relatively low halloysite concentrations than at higher concentrations.

TABLE 1
Mechanical properties of halloysite/Viton composites

| | Filler | Tensile | Tensile | Toughness |
|---|---|---|---|---|
| | Level | stress at max. | strain at max. | (in · lbf/ |
| Material | (wt %) | load (psi) | load (%) | in³) |
| Viton Control | 0 | 1640 | 176 | 1110 |
| Viton + | 5 | 2040 | 252 | 2670 |
| Halloysite | | | | |
| Viton + | 10 | 1970 | 203 | 2324 |
| Halloysite | | | | |

The enhanced mechanical properties are attributed to the inherent mechanical strength and high aspect ratio of the halloysite nanotubes. The composition maintains the chemical stability, thermal stability and low coefficient of friction imparted by the fluoroelastomer.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

What is claimed is:

1. A polymer composite, comprising:
a fluoroelastomer binder; and
a plurality of halloysite nanotubes dispersed in the fluoroelastomer binder.

2. The polymer composite of claim 1, wherein the plurality of halloysite nanotubes have an average aspect ratio of at least 5.

3. The polymer composite of claim 1, wherein the plurality of halloysite nanotubes are present in an amount less than 20 weight %, based on the total weight of dried solids of the polymer composite.

4. The polymer composite of claim 1, wherein the plurality of halloysite nanotubes are present in an amount ranging from about 1 weight % to about 15 weight %, based on the total weight of dried solids of the polymer composite.

5. The polymer composite of claim 1, wherein the plurality of halloysite nanotubes are present in an amount ranging from about 3 weight % to about 10 weight %, based on the total weight of dried solids of the polymer composite.

6. The polymer composite of claim 1, wherein the polymer composite has a surface free energy ranging from about 18 mN/m to about 28 mN/m.

7. The polymer composite of claim 1, wherein the nanocomposite material has at least one property chosen from a) a tensile strength ranging from about 600 psi to about 5000 psi; b) a toughness ranging from about 1000 in·lbf/in³ to about 5000 in·lbf/in³; or c) a percentage ultimate strain ranging from about 100% to about 600%, where the percentage ultimate strain is determined using a universal INSTRON testing machine.

8. The polymer composite of claim 1, wherein the fluoroelastomer binder is a cross-linked polymer made by combining a cure site monomer and a monomeric repeating unit selected from the group consisting of a vinylidene fluoride, a hexafluoropropylene, a tetrafluoroethylene, a perfluoro(methyl vinyl ether), a perfluoro(propyl vinyl ether), a perfluoro(ethyl vinyl ether) and combinations thereof.

9. The polymer composite of claim 1, wherein the fluoroelastomer is made by cross-linking a vinylidene fluoride using at least one curing agent selected from a group consisting of a bisphenol compound, a diamino compound, an aminophenol compound, an aminosiloxane compound, an aminosilane compound and a phenolsilane compound.

10. A xerographic printing device component comprising:
a substrate; and
a nanocomposite layer formed on the substrate, the nanocomposite layer comprising a fluoroelastomer binder and a plurality of halloysite nanotubes dispersed in the fluoroelastomer binder.

11. The xerographic printing device component of claim 10, wherein the article is a xerographic component selected from the group consisting of a fuser member, a fixing member, a pressure roller and a release agent donor member.

12. The xerographic printing device component of claim 11, wherein the substrate comprises at least one material selected from the group consisting of glass, silicon, metals, ceramics, plastics and elastomers.

13. The xerographic printing device component of claim 12, wherein the plurality of halloysite nanotubes have an average aspect ratio of at least 5.

14. The xerographic printing device component of claim 13, wherein the halloysite nanotubes have a concentration of less than 20% by weight, based on the total weight of the nanocomposite layer.

15. The xerographic printing device component of claim 13, wherein the plurality of halloysite nanotubes are present in an amount ranging from about 1 weight % to about 15 weight % based on the total weight of the nanocomposite layer.

16. The xerographic printing device component of claim 15, wherein the plurality of halloysite nanotubes are present in an amount ranging from about 3 weight % to about 10 weight %, based on the total weight of the nanocomposite layer.

17. The xerographic printing device component of claim 15, wherein the fluoroelastomer binder is a cross-linked polymer made by combining a cure site monomer and a monomeric repeating unit selected from the group consisting of a vinylidene fluoride, a hexafluoropropylene, a tetrafluoroethylene, a perfluoro(methyl vinyl ether), a perfluoro(propyl vinyl ether), a perfluoro(ethyl vinyl ether) and combinations thereof.

18. The xerographic printing device component of claim 15, wherein the fluoroelastomer is made by cross-linking a vinylidene fluoride-using at least one curing agent selected from a group consisting of a bisphenol compound, a diamino compound, an aminophenol compound, an aminosiloxane compound, an aminosilane compound and a phenolsilane compound.

19. The xerographic printing device component of claim 15, wherein the nanocomposite layer further comprises a conductive filler.

20. A fuser comprising:
a substrate; and
a nanocomposite layer formed on the substrate, the nanocomposite layer comprising a fluoroelastomer binder and a plurality of halloysite nanotubes dispersed in the fluoroelastomer binder, the plurality of halloysite nanotubes have an average aspect ratio of at least 5,
wherein the halloysite nanotubes have a concentration of less than 20% by weight, based on the total weight of the nanocomposite layer; and
wherein the nanocomposite layer formed on the substrate has a tensile strength ranging from about 600 psi to 5000 psi; a toughness ranging from about 1000 in·lbf/in³ to about 5000 in·lbf/in³; and a percentage ultimate strain ranging from about 100% to about 600%.
